(19) United States
(12) Patent Application Publication
(10) Pub. No.: US 2017/0354171 A1
(43) Pub. Date: Dec. 14, 2017

(54) PROCESS FOR PREPARING READY-TO-EAT COCONUT

(71) Applicant: Surachai Wattanaporn, Nakhonpathom (TH)

(72) Inventor: Surachai Wattanaporn, Nakhonpathom (TH)

(21) Appl. No.: 15/611,235

(22) Filed: Jun. 1, 2017

(30) Foreign Application Priority Data
Jun. 11, 2016 (TH) 1603001036

(51) Int. Cl. A23L 3/10; A23L 5/20; A23L 5/10

(52) U.S. Cl. CPC A23L 3/10; A23L 5/15; A23L 5/21; A23V 2002/00

(57) ABSTRACT

A process for preparing a ready-to-eat mature coconut in which coconuts are selected based on its flotation characteristics, higher floaters being more mature. An oval or circular groove is carved partially into the bottom of the coconut shell. The coconut is then sealed into a heat tolerant plastic bag in which it is cooked, then frozen. Pieces of coconut husk are roasted until they turn black, then boiled in water to obtain a vapor that condenses to a liquid extraction, which is added to the bag before sealing it. The sealed bag is then heated to obtain sweet coconut water, some separation of coconut meat from the coconut shell, and the expansion of the coconut water during the spraying of steam to slightly split the coconut shell along the carved groove whereby the tip of a spoon can be used to pry off the coconut shell.

### CROSS-REFERENCE TO RELATED APPLICATIONS

This application claims the benefit of Thai Patent Application No. 1603001036, filed Jun. 11, 2016, the disclosure of which is incorporated herein by reference.

### FIELD OF THE INVENTION

This invention involves food process engineering and technology of ready-to-consume coconut with taste and flavor that meet the demand of consumers.

### BACKGROUND OF THE INVENTION

Regarding international trade experiences, especially in food and drinks process for export both in Europe and the United States for over many years until present, it is factual that drinks that are generally trending are focused on health and are natural products such as fruit juice, orange juice, apple juice, and various vegetable juice like carrot, beetroot, tomato, and the like. These beverages usually require an extraction process, including fresh squeezing to separate residue before drinking to keep its vitamins and nutrition. For drinks, besides water, only coconut water has sufficient volume for drinking without extracting or squeezing to separate residue. Coconut water is a natural product, sweet with a more attractive aroma than water, and favored by many people. It is accepted that the coconut water has nutritional benefits. In addition, the consumption of coconut meat provides nutrition that gives energy and benefits to the body. As a result, there is research, development, manufacture and marketing to meet the demand of coconut consumption in various forms of product. This includes the simplest form, which is the selling of fresh coconut by using a chopping knife to open the coconut shell. This requires skill and is not convenient for general consumers. In addition, the shelf life of the fresh coconut is short and its taste will change on storage. There is a process to make the taste of the coconut, especially the coconut water, to be sweeter than unprocessed coconut water, and with a unique aroma, by roasting the whole coconut. Boiling or steaming can be applied instead of roasting. The coconut water becomes sweeter but lacks the aforementioned aroma. Nevertheless, the demand for coconut water consumption is still a problem. Chopping to open the coconut shell is still required.

There also remains an issue of how to classify whether a coconut is young or more mature, the layer of its coconut meat having different thicknesses and maturities hardness. These factors affect the taste of the coconut water, which can have different levels of sweetness. Classification also requires individual skills of visual estimation of whether a coconut is mature or young. There is a risk that misclassified coconuts may not comply with their expectation. Therefore, there is a need for a classification process that is simple but accurate and convenient to replace current procedures requiring individual skills.

### BRIEF SUMMARY OF THE INVENTION

In accordance with the present invention, a new manufacturing process is provided that solves the foregoing problems. A manufacturing process for ready-to-consume coconut with roasted coconut flavor is provided suitable for the export of the so-processed coconut.

A first objective of this invention is to classify fresh coconut into young coconut and more mature coconut with thick or thin coconut meat, which is suitable to manufacture ready-to-consume coconut water. The classification method is effective, accurate and simple, with low cost.

A second objective of this invention is to provide a manufacturing process in the preparation step of fresh coconut that has been classified according to the thickness of the coconut meat as mentioned above. To be ready for the manufacturing process, a tool is used to mark each coconut shell. The husk of the coconuts will be removed to provide processed coconuts having an appropriate shape to be at approximately the same height

Another objective of this invention is to arrange a tool to mark each coconut shell with an oval shape on the top of the coconut shell by using a diamond head wood carving tool or a low power laser beam. The oval groove will be slightly deep but not cut through to the coconut meat. This is to prevent pathogens, bacteria and contaminant from entering and damaging the coconut meat and water, which are principal causes for the coconut meat and water to lose their taste and aroma, becoming rotten and have a short shelf life.

Still another objective of the invention is to obtain a liquid manufacturing process to provide a roasted coconut flavor by roasting coconut scaly residue and coconut husk, and adding the resultant roasted coconut aroma and extracted flavor into a vacuum-packed coconut in a retort pouch bag. This process substitutes the roasting of the whole coconut to meet production needs and the demand of consumers.

Succinctly, a process is provided for preparing a ready-to-eat mature coconut in which the coconuts are selected based on its flotation characteristics, higher floaters being more mature. An oval or circular groove is carved partially into the bottom of the coconut shell. The coconut is then sealed into a heat tolerant plastic bag in which it is cooked, then frozen. Pieces of coconut husk are roasted until they turn black, then boiled in water to obtain a vapor that condenses to a liquid extraction, which is added to the bag before sealing it. The sealed bag is then heated to obtain sweet coconut water, some separation of coconut meat from the coconut shell, and the expansion of the coconut water during the spraying of steam, which may or may not slightly split the coconut shell along the carved groove but in any event splitting along the groove will occur following the freeze step whereby the tip of a spoon can be used to pry off the coconut shell.

The invention also provides a ready-to-eat coconut prepared by the foregoing process.

### BRIEF DESCRIPTION OF THE DRAWINGS

For a more complete understanding of the present invention, reference is now made to the following descriptions taken in conjunction with the accompanying drawing, in which:

FIGS. 1A and B shows the classification process of the fresh coconut to determine young coconut or more mature coconut with various thickness of the coconut meat;

FIGS. 2A and B show the removal coconut shell and husk to obtain the same height for every coconut;

FIG. 3A shows marking by a diamond head wood carving tool;

FIG. 3B shows the marking process on a coconut using a laser beam to cut a mark into the coconut shell to enable the handle of a spoon to pry off the top of the coconut shell;

FIG. 4 shows tools and a process to roast the coconut husk and shell to extract a roasted coconut flavor;

FIG. 5 shows tools and an extraction process for the roasted husk and shell to obtain liquid with a roasted coconut aroma;

FIG. 6 shows the packing of the coconut into a heat tolerant clear plastic retort pouch bag and adding the roasted coconut extracted flavor;

FIG. 7 shows heat sealing of the clear plastic bag under vacuum;

FIG. 8 shows the packed coconut bag for boiling or steam treatment in a steam retort or tank, to make the coconut water sweeter and separate some of the coconut meat from the coconut shell to substitute for roasting of the whole coconut;

FIG. 9 shows boiling and steam treatment of the packaged coconut in the steam retort or tank;

FIG. 10 shows the cool down process to the specified temperature;

FIG. 11 shows the blow drying of a packed coconut bag using a fan;

FIG. 12 shows the packaging of a metal spoon and straw in a separate plastic bag;

FIG. 13 shows the packed spoon and straw with the packed coconut bag;

FIG. 14 shows a conveyor and device for reducing the temperature of packed coconut bags to two degree Celsius and freezing to temperature of −5 to −10 degree Celsius using a blast freezer spray with extreme cold air at high velocity;

FIGS. 15A, B and C show the method of using the handle of a spoon to pry the coconut shell along the oval groove and pierce the straw through the coconut meat to drink the coconut water, and

FIG. 16 shows the application of the spoon to consume the coconut meat.

### DETAILED DESCRIPTION OF THE INVENTION

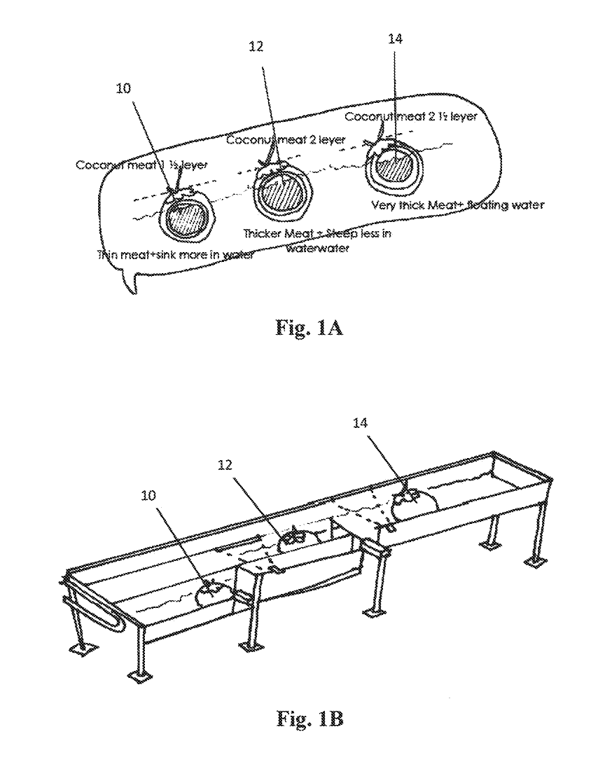

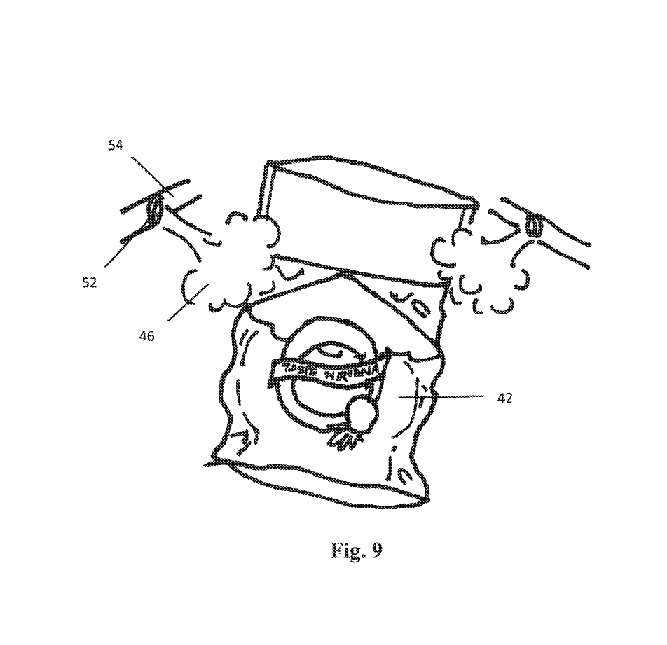

The invention provides a process to open the coconut shell by marking it with a cutting tool as described above to form an oval or circular shaped line. It will then be easy to open the resulting coconut shell using only a tablespoon, which can be is attached with package, to pry along the oval groove. With only minimal force, the top coconut shell can be detached along the marking line, separating it from the coconut meat. A straw, which can be attached to the package, can be pierced through coconut meat, ready for drinking the coconut water. A tablespoon can be used for the coconut meat; some coconut meat may be separated from the coconut shell. Principles and procedures of ready-to-consume coconut with roasted coconut extracted flavor for export are shown in FIG. 1-FIG. 16.

Referring to FIG. 1, fresh coconut is classified to determine whether the coconut is young or more mature with various thickness of the coconut meat. The coconut is floated in water to observe the part that floats above the water and the part that sinks into the water. With a young coconut 10 (or what a coconut grover calls 1 and ½ layers of meat), almost all of the coconut sinks below the surface of the water. This shows that the coconut meat in that coconut is thin and has a large volume of the coconut water in the coconut so that there is almost no empty space inside that coconut. A coconut 12 with thicker coconut meat, which is called 2 layers of meat; will have less coconut water and have more empty space inside that coconut. Therefore, the part that floats above the water is more than 5% of the coconut. A coconut 14 with very thick coconut meat, which is called 2 and ½ layers of meat; will have even less coconut water and even more empty space inside the coconut. Therefore, the part that floats above the water is more than 10% of the coconut. In summary, as appropriate, only the 2 layers and 2 and ½ layers coconut 12 or 14 will be used as raw material for the manufacturing process according to the invention. This is because the product will provide sweet coconut water and has sufficient coconut meat that meets the consumption demand.

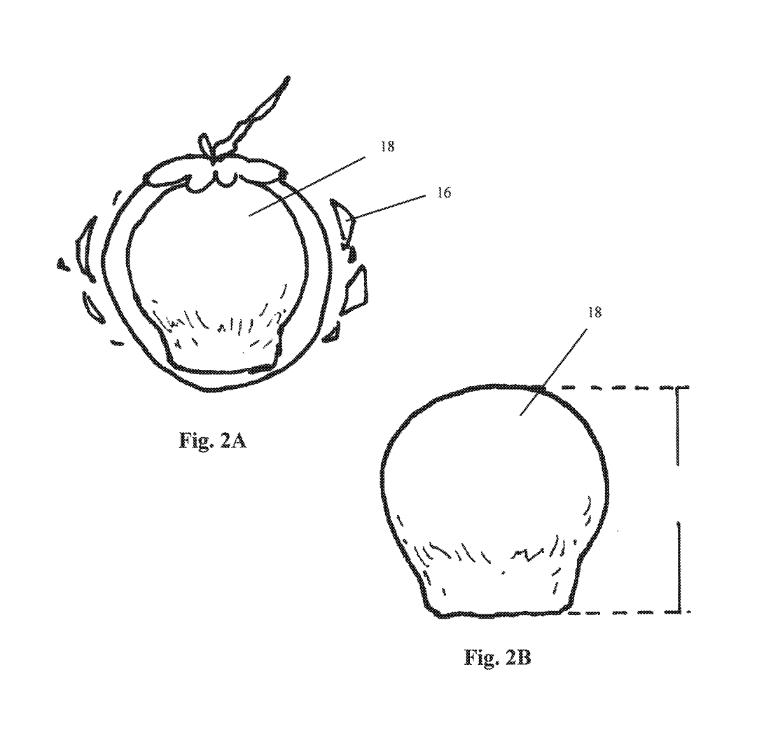

Referring to FIG. 2A, most of the husk 16 of the classified coconut is removed until the coconut shell 18 appears both at the top and on the side, keeping some at the bottom. The husk and shell at the pole of the coconut remains. Then each coconut is trimmed evenly to have approximately the same height as shown in FIG. 2B. The height is in the range of 110-120 millimeters and the diameter is about 90-100 millimeters. This makes it more convenient to adjusting the distance of the tool head, which creates a mark on the coconut, to be stable throughout the process line.

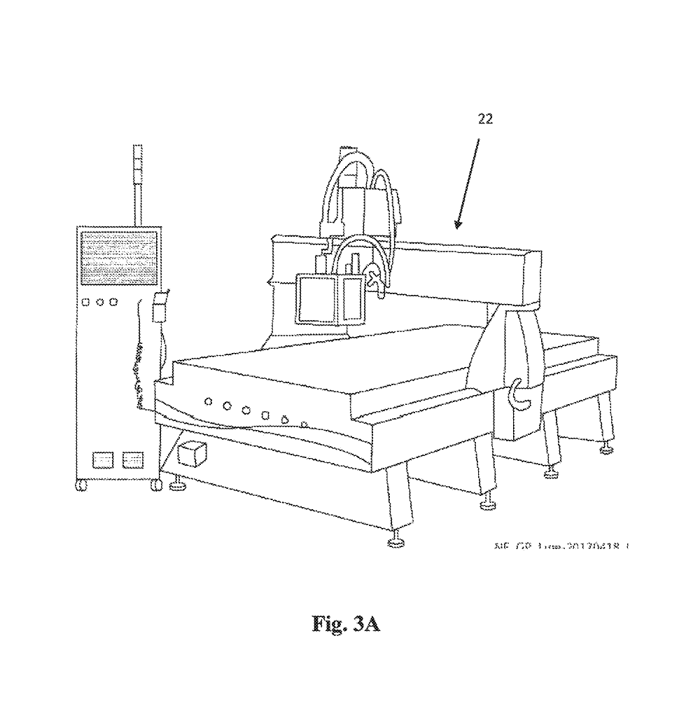

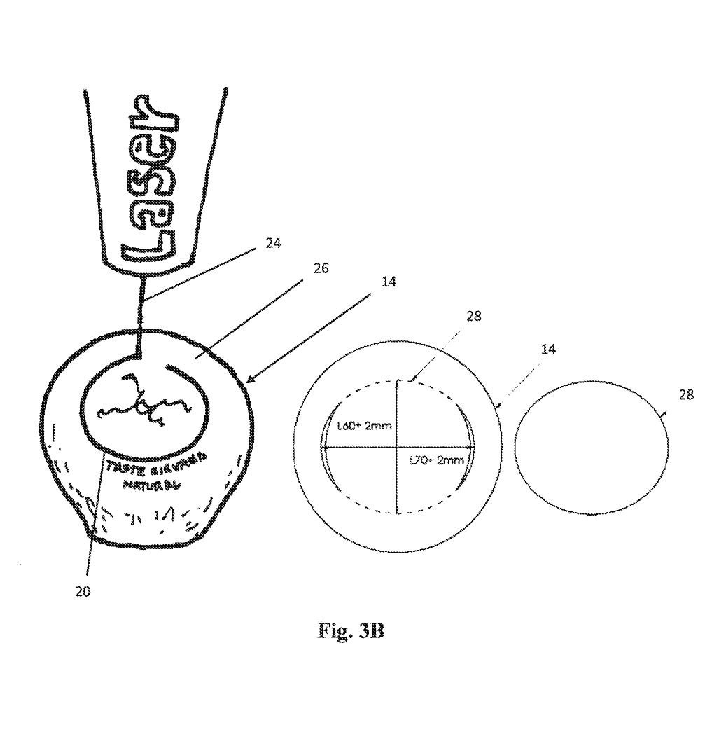

Referring to FIGS. 3A and 3B, the coconut is marked or grooved to a depth such that a tablespoon handle can be used by a consumer to pry open the coconut shell. Tools generally available that can be used include wood carving tools, diamond headed drilling tools, and rotators, which can be applied as shown in FIG. 3A. These tools are available for various industrial uses depend on their applications such as carving of wooden doors, gourd, and various patterns, for example by using a mechanical mechanism to control a diamond headed drill. A microprocessor will operate according to the distance, depth, and groove guideline, which is specified by programmable software.

Alternatively, as shown in FIG. 3B, a low power laser beam can be used, as normally applied in industries, to mark or groove the coconut shell to the desired depth. The laser beam is emitted according to a specified focus at the bottom 26 of the coconut. The concentration of the laser beam with high heat will create a burning mark or groove 20 on the coconut shell at the focused point until a partially cut-through lid 28 is formed in the shape of an oval or a circle. Variations may be utilized. For example, instead of an oval or circular groove, one can carve a shape of any design in which one end of the groove meets the other end whereby the groove closes in on itself to allow the lid to be removed.

In a specific embodiment, the laser beam can cut the outline of the lid, e.g., as a circle or an oval with dimensions of 60+/−2 mm long and 60+/−2 mm wide. The depth is not entirely through the coconut shell so that it avoids reaching the coconut meat layer, as shown in FIG. 3B. For example, with a coconut shell thickness of 1.8+/−1 mm, the depth of cut of the laser beam can be 1.4+/−1 mm, leaving 0.4+/−1 mm of shell. This prevents pathogen, bacteria, and/or contaminants from outside the coconut from damaging the coconut meat and coconut water, which is a principal cause of coconut meat and coconut water losing its taste and aroma, becoming rotten, and having a short shelf life.

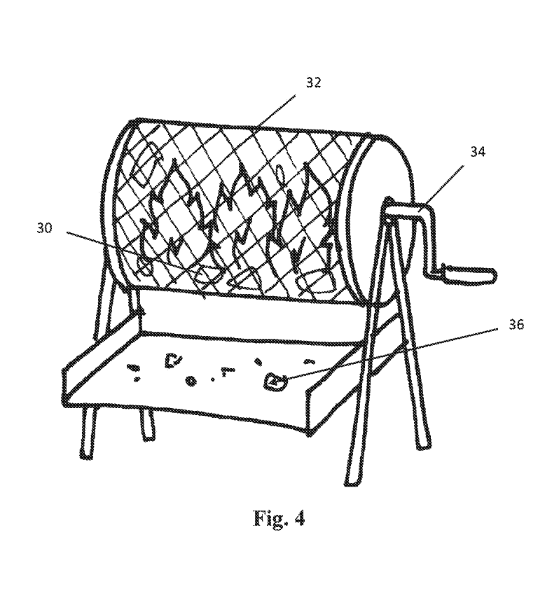

FIG. 4 illustrates an extraction procedure to obtain a roasted coconut flavor. The raw material can be prepared by chopping coconut husk and coconut shell into pieces 30 of approximately two inches long. The pieces are put into a cylindrical sieve container 32, which is installed on a manual axel 34 that rotates through a fire 36 underneath the container 32. A method is thus provided for roasting the coconut shell and coconut husk at a temperature of 400-1,000 degree Celsius rotated through the heat for 10-20 minutes until the coconut husk and coconut shell are burnt and turned black. After that, it will be used as raw material for preparing a roasted coconut aroma flavored extract.

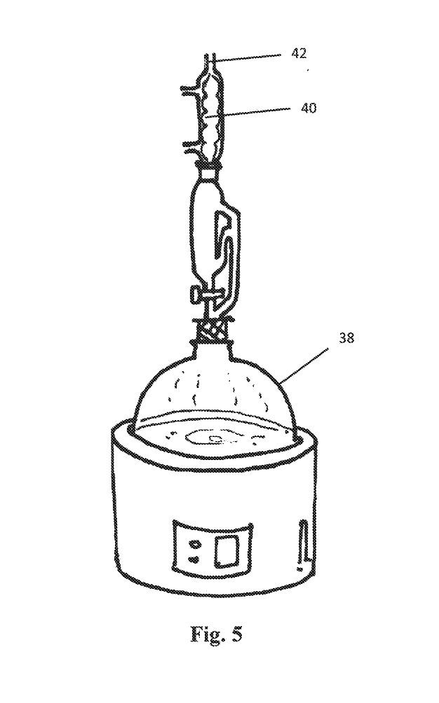

Referring to FIG. 5, the burnt raw material is mixed with water in a boiling container 38 at a temperature of 90-100 degree Celsius for a time sufficient for it to turn into vapor 40, e.g., 20 minutes or more. This vapor 40 contains aroma from the roasting of the coconut husk and shell. The vapor 40 flows through a pipe to cooling quenching equipment to condense the vapor to liquid with roasted coconut aroma.

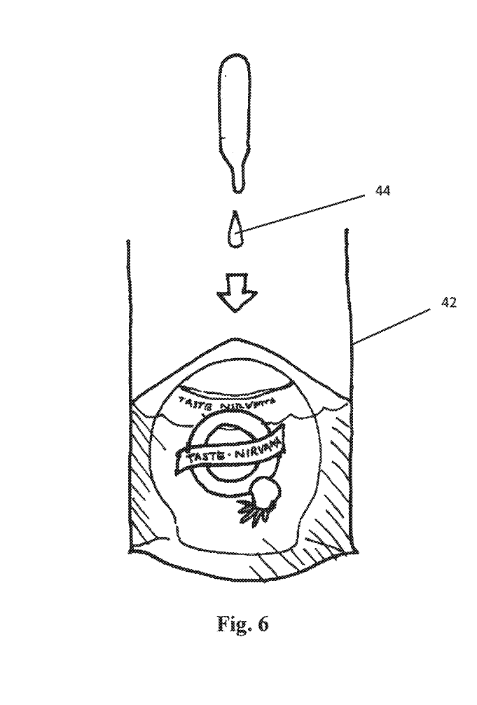

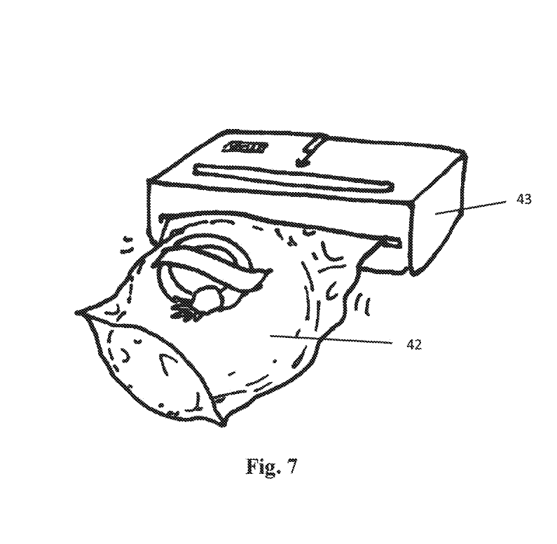

FIG. 6 illustrates the procedure to pack the coconut in a heat tolerant plastic bag 42, which can withstand heat at 100-120 degree Celsius (because the bag will be boiled). Then the liquid 44 with roasted coconut aroma of approximately 10-15 cc. is added into the bag 42 containing the coconut. Referring to FIG. 7, the bag 42 is sealed using a vacuum plastic bag sealer 43. The vacuum system will suck out all air inside the bag and seal the bag using heat to melt the plastic around the bag's opening of both sides. When the bag 42 is exposed to room temperature, the sealed bag 42 cools down. Other substances and air can no longer entering the plastic bag 42 containing the coconut.

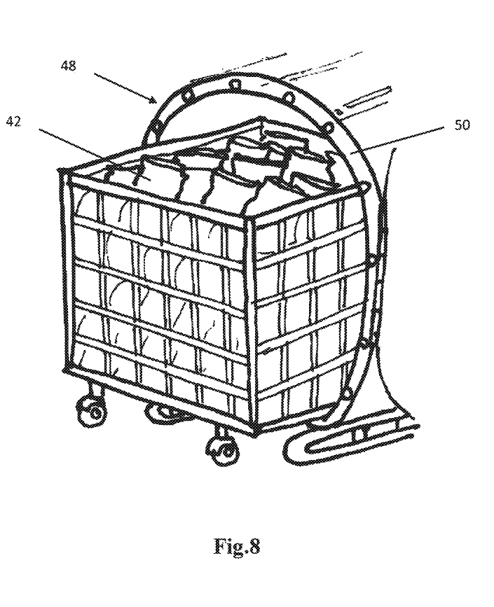

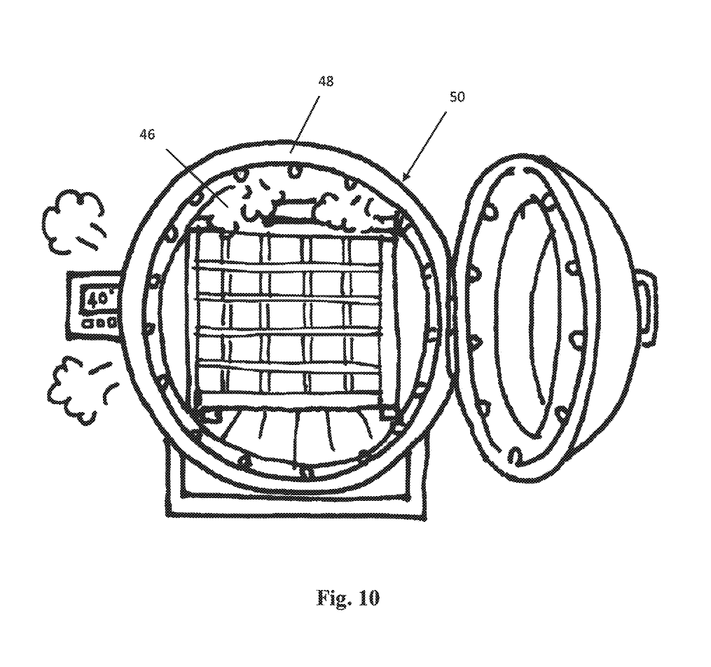

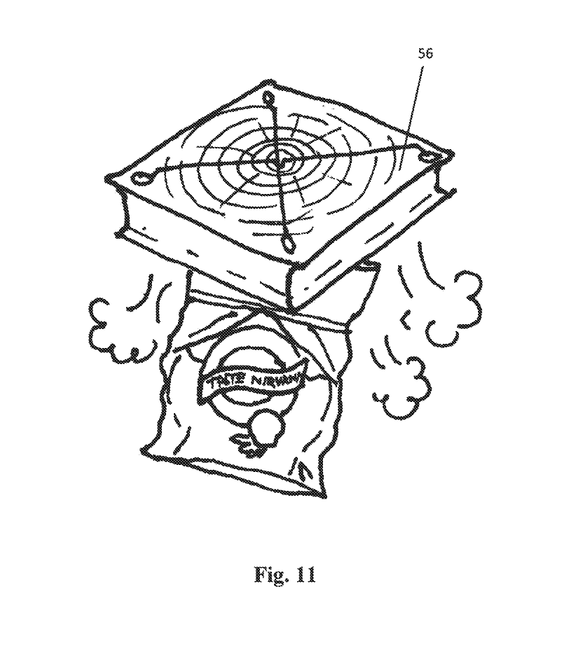

Referring to FIGS. 8-10, a plurality of sealed plastic bags 42 are sprayed with steam 46 in a steam retort or tank 48. This steam retort 48 is a huge horizontal cylinder 50 with a heat resistant and water boiling system to generate steam 46 through small pipes 52 into steam injectors 54, which are located inside the steam retort 48. The steam injectors 54 spray steam 46 at a temperature of 100 degree Celsius to the packed coconut plastic bags 42, preferably for at least 30 minutes. This cooks and sterilizes the coconut to provide a product like that produced by the prior art practice of roasting the coconut. When the steam 46 is sprayed onto the sealed bags 42, the coconut water and the coconut meat will receive heat long enough to react into the product. The coconut becomes sweeter and the coconut meat becomes loosely attached to the coconut shell. Some of the coconut may separate from the coconut shell, and the coconut shell can be broken slightly along the previously carved oval or circle groove 20 (see FIG. 3B). At the same time, the liquid 44 with roasted coconut aroma, which is added in to the coconut; will absorb into the coconut shell, coconut meat, and coconut water when it is heated. The temperature of the steam retort is then decreased to 40-50 degree Celsius (as shown in FIG. 10). Referring to FIG. 11, finally, the packed coconut bag is blown dry by a blower 56.

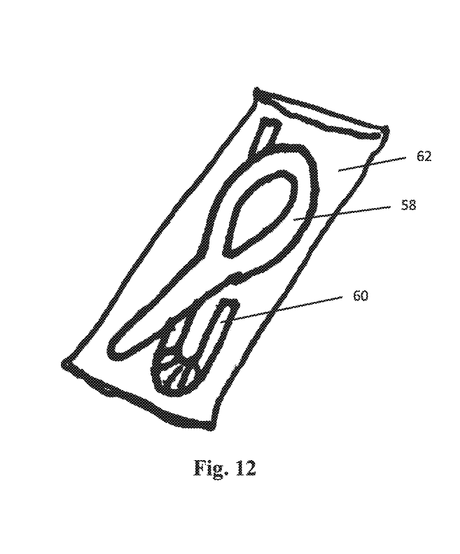

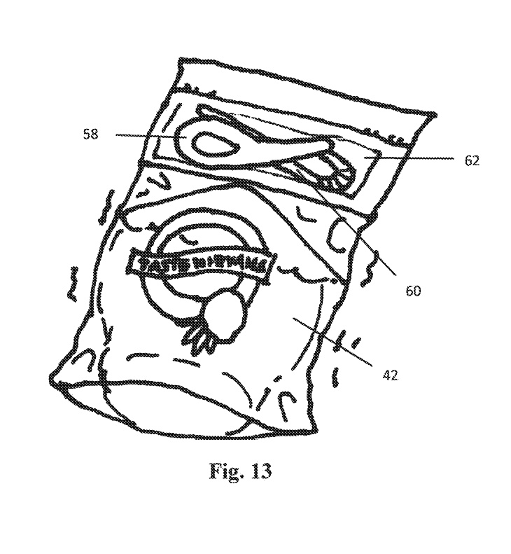

Referring to FIG. 12, a tablespoon 58, which can be formed of a stiff material, such as metal, is packed together with a straw 60 in a separate plastic bag 62 which has a width about the same as or smaller than the packed coconut bag 42. The bag can be opaque but is preferably clear, transparent or translucent. Referring to FIG. 13, the bag 62 containing the spoon 58 and straw 60 is sealed together with the packed coconut bag 42 using the sealer 44 previously described.

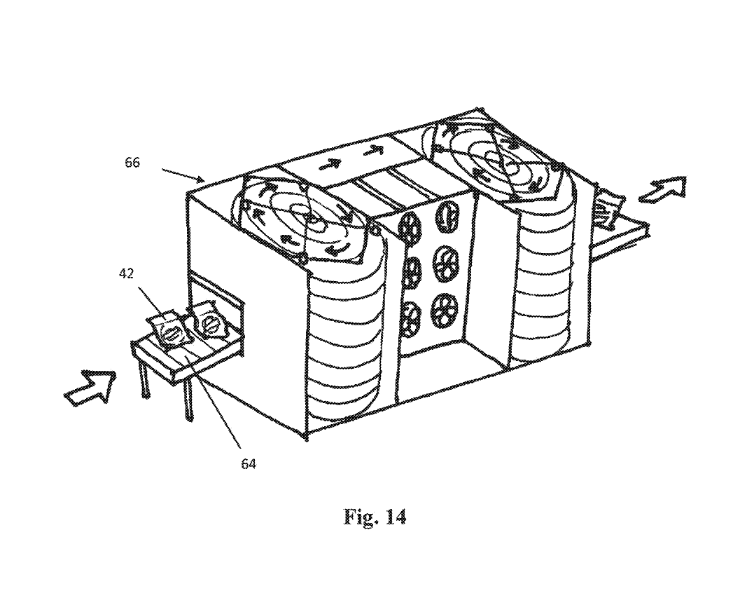

FIG. 14 schematically shows the processed plastic bags 42 carried on a moving belt 64 into a blast freezer, which blows cold air at high velocity to reduce the temperature to −5 to −20 degree Celsius. This will cause the coconut water to expand and pushout the coconut meat and coconut shell to split along the carved oval or circle lid 28 (see FIG. 3). The splitting is just sufficient to enable one to use the tip of the metal tablespoon to pry the coconut shell lid 28 along the carved groove 20 to come off easily.

The ready-to-eat coconut with roasted coconut flavor is stored at a temperature of −5 to −20 degree Celsius until it reaches customers. It will be frozen in the freezer until the consumption time when it will be moved to a refrigerator. This is the same as normal frozen food consumption. When used, the frozen coconut is thawed until the temperature is approximately 5-10 degree Celsius, which is sufficient for consumption.

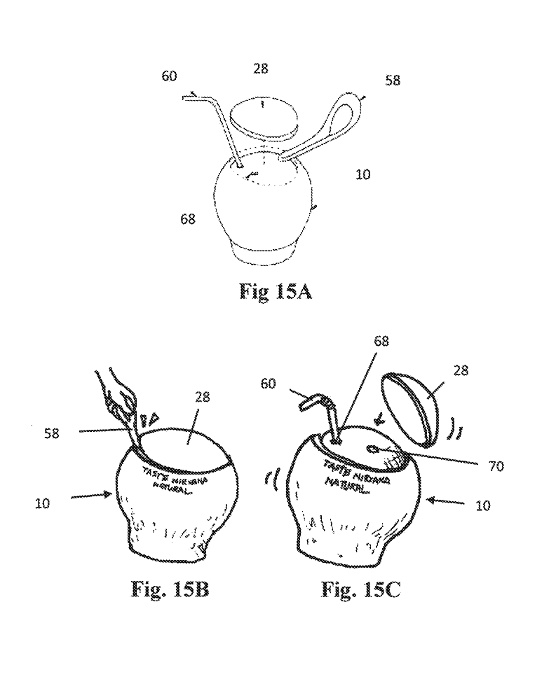

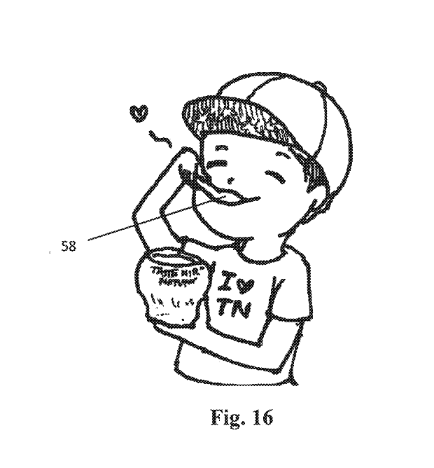

Referring to FIGS. 15A-5C, the tip of the tablespoon 58 will open the coconut shell and the drinking straw 60 used to make two holes 68 and 70 through the coconut meat to enable one to drink the coconut water. After that, as shown in FIG. 16, the tablespoon 58 is used to get the coconut meat for consumption, which is easy to do because the coconut meat is separated from the coconut shell as a result of the manufacturing process of this invention.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims.

1. A process for preparing a ready-to-eat coconut
carving a groove into but not through the bottom of the shell of the coconut;
sealing the resultant coconut into a heat tolerant plastic bag;
cooking the coconut while sealed in the plastic bag; and
freezing the cooked coconut while sealed in the plastic bag.

2. The process of claim 1 in which the carved groove is oval or circular.

3. The process of claim 1, wherein the coconut used in the process is selected according to the maturity of the coconut meat inside the coconut.

4. The process of claim 3, wherein the maturity of the coconut meat is determined using a classification method whereby coconuts are floated and classified according to the floating characteristics of the coconuts.

5. The process of claim 4 in which the coconut used in the process of this invention has 2 or 2 and ½ layers of meat.

6. The process of claim 1 in which the husk of the coconut is cut away to form a resulting coconut having a predetermined shape.

7. The process of claim 6 wherein the resulting coconut has a height is in the range of 110-120 millimeters and a diameter in the range of 90-100 millimeters.

8. The process of claim 1 wherein the groove leaves approximately 0.4+/−1 millimeter of shell.

9. The process of claim 1 including roasting pieces of coconut husk for a time sufficient for it to turn black, then boiling the blackened pieces of husk in water to obtain a vapor which is condensed a liquid extraction with the aroma of roasted coconut.

10. The process of claim 9 wherein the pieces of coconut husk are roasted at a temperature of 400-1,000 degree Celsius for 10-20 minutes and the blackened pieces of husk is boiled at 90-100 degree Celsius for 20 minutes or more to obtain the liquid extraction.

11. The process of claim 9 wherein the liquid extraction is added to the heat tolerant plastic bag before sealing the bag.

12. The process of claim 11 in which approximately 10-15 cc of the liquid extraction is added to the bag.

13. The process of claim 1 in which the heat tolerant bag can withstand heat of 100-110 degrees Celsius.

14. The process of claim 1 wherein, after the heat resistant bag is sealed, it is vacuum sealed and then sprayed with steam or hot water sufficient to cook and sterilize the coconut.

15. The process of claim 14 wherein the temperature and time at which the sealed bag is heated is sufficient for the coconut meat and coconut water to react chemically and change its physical properties whereby to obtain sweet coconut water, some separation of coconut meat from the coconut shell, and the expansion of the coconut water during the spraying of steam, which may or may not slightly split the coconut shell along the carved groove.

16. The process of claim 15 wherein the bag is cooked and sterilized at a temperature of 100 degree Celsius for at least 30 minutes, following which the temperature of the bag is gradually decreased to 40-50 degree Celsius and blown dry.

17. The process of claim 1 in which a spoon and a straw that are attached separately in a plastic bag and sealed together with the heat tolerant bag containing the cooked coconut.

18. The process of claim 1 in which the cooked coconut is frozen to −5 to −20 degrees Celsius, which causes the coconut water to expand and push the coconut meat and coconut shell to split along the carved groove, sufficient to enable use of the tip of a spoon to pry off the coconut shell along the carved groove.

19. A ready-to-eat coconut prepared by the process of claim 1.

20. The coconut of claim 19 in which a liquid extraction is added before the coconut is sealed into the heat tolerant plastic bag, the extraction being prepared by roasting pieces of coconut husk for a time sufficient for it to turn black, then boiling the blackened pieces of husk in water to obtain a vapor which is condensed a liquid.
